(19) United States
(12) Patent Application Publication
(10) Pub. No.: US 2012/0139969 A1
(43) Pub. Date: Jun. 7, 2012

(54) IMAGE DISPLAY DEVICE

(75) Inventors: Junichi YOKOYAMA, Fujisawa (JP); Masahisa Tsukahara, Fujisawa (JP); Hajime Akimoto, Kokubunji (JP)

(73) Assignees: CANON KABUSHIKI KAISHA; Hitachi Displays, Ltd.

(21) Appl. No.: 13/308,620

(22) Filed: Dec. 1, 2011

(30) Foreign Application Priority Data
Dec. 6, 2010 (JP) 2010-271803

(51) Int. Cl. G09G 5/10

(52) U.S. Cl. 345/690

(57) ABSTRACT

An image display device includes plural pixel circuits each of which includes a light emitting element where an amount of light emission changes corresponding to an amount of current and a drive transistor which controls the amount of current which flows to the light emitting element based on a display signal, a data line drive circuit which supplies a display signal to the plural pixel circuits respectively based on image data, a power source part which outputs a light-emitting potential, and a current amount prediction part which calculates an amount of current which flows to the plural pixel circuits from the power source part based on the image data. The power source part performs a control for suppressing fluctuation of the light-emitting potential based on the calculated amount of current and the outputted light-emitting potential.

### CROSS-REFERENCE TO RELATED APPLICATION

The present application claims priority from Japanese application JP2010-271803 filed on Dec. 6, 2010, the content of which is hereby incorporated by reference into this application.

### BACKGROUND OF THE INVENTION

1. Field of the Invention

The present invention relates to an image display device, and more particularly to an image display device using light emitting elements.

2. Description of the Related Art

Recently, the development of an image display device which uses light emitting elements such as an organic EL display device has been vigorously underway. Plural pixel circuits are arranged in a display region of an image display device, and each pixel circuit includes a light emitting element. A power source circuit which generates a potential for light emission is provided for supplying an electric current for making respective light emitting elements emit light.

FIG. 19 shows an example of the constitution of a conventional power source circuit. The power source circuit shown in FIG. 19 includes a power source input terminal to which a power source potential VDD is inputted, an inductance L1, a power source control switch Q1, a diode D1, a first resistor R1, a second resistor R2, a stabilization capacitor C1, an error amplifier ERA, an integration capacitor C2, a reference voltage source SVR, and a power source control switch control circuit SCC. One end of the inductance L1 is connected to the power source input terminal, and an anode of the diode D1 and one end of the power source control switch Q1 are connected to the other end of the inductance L1. A ground potential is supplied to the other end of the power source control switch Q1. Here, the power source control switch Q1 is a field effect transistor. A cathode of the diode D1 is connected to one end of the stabilization capacitor C1, and a ground potential is supplied to the other end of the stabilization capacitor C1. Also one end of the first resistor R1 is connected to one end of the stabilization capacitor C1, the second resistor R2 is connected to the other end of the first resistor R1, and a ground potential is supplied to the other end of the second resistor R2. The error amplifier ERA includes a first input terminal, a second input terminal and an output terminal, and the integration capacitor C2 is provided between the first input terminal and the output terminal. Due to such a constitution, the error amplifier ERA and the integration capacitor C2 are operated as an integrator circuit. The first input terminal of the error amplifier ERA is connected to the other end of the first resistor R1, the second input terminal of the error amplifier ERA is connected to the reference voltage source SVR, and the output terminal of the error amplifier ERA is connected to the power source control switch control circuit SCC. Further, the power source control switch control circuit SCC is connected to a gate electrode of the power source control switch Q1. This power source circuit constitutes a switching regulator.

In the above-mentioned power source circuit, a potential higher than the power source potential VDD is generated in the inductance L1 when the power source control switch Q1 is turned on or off and, due to such a high potential, an electric current flows to the stabilization capacitor C1 from the inductance L1 through the diode D1. A potential generated by a charge stored in the stabilization capacitor C1 due to such an electric current is supplied to a pixel circuit as a potential for light emission through a power source line PWL. The electric current which flows through the power source line PWL is referred to as a light-emitting current Ioled. Further, a feedback control is performed for bringing the potential for light emission to a target potential. To be more specific, the difference between a potential obtained by dividing a potential for light emission by the first resistor R1 and the second resistor R2 (a potential supplied to the first terminal) and a reference potential (a potential supplied to the second input terminal) is detected by the error amplifier ERA, and the power source control switch control circuit SCC controls whether the power source control switch Q1 is turned on or off based on a detection result of the error amplifier ERA. As a method by which the power source control switch control circuit SCC controls the power source control switch Q1, for example, a PWM control is used.

US2005/0179627 discloses an example of the above-mentioned power source circuit used in an image display device.

In an image display device which uses light emitting elements, an amount of current which flows through the light emitting element changes corresponding to brightness of the light emitting element. In a power source circuit which performs a feedback control, there may be a case where a feedback control cannot catch up with a change in an amount of current. In such a case, a potential for light emission may fluctuate thus also bringing about the deterioration of image quality or the like.

### SUMMARY OF THE INVENTION

The present invention has been made under such circumstances, and it is an object of the present invention to provide an image display device where it is possible to suppress the fluctuation of a potential for light emission caused by a change in an amount of current which flows to a light emitting element.

To briefly explain the summary of the typical inventions among the inventions described in this application, they are as follows.

(1) According to one aspect of the present invention, there is provided an image display device including: plural pixel circuits each of which includes a light emitting element where an amount of light emission changes corresponding to an amount of current and a drive transistor which controls the amount of current which flows to the light emitting element based on a display signal; a data line drive circuit which supplies the display signal to the plural pixel circuits respectively based on image data; a power source part which outputs a potential for light emission; and a current amount prediction part which calculates the amount of current which flows into the plural pixel circuits from the power source part based on the image data, wherein the power source part performs a control for suppressing fluctuation of the potential for light emission based on the calculated amount of current and the outputted potential for light emission.

(2) In the image display device having the constitution described in (1), the power source part includes: a power source input terminal to which a power source potential is inputted; a switch which controls whether or not a current from the power source input terminal is allowed to flow based on the calculated amount of current and the potential for light emission; and a capacitor which has one end to which the potential for light emission is applied.

(3) In the image display device having the constitution described in (2), the power source part further includes: an inductance which is provided between the power source input terminal and one end of the switch; and a rectifying element which is provided between one end of the switch and one end of the capacitor.

(4) In the image display device having the constitution described in any one of (1) to (3), the power source part includes: a feedback, voltage adjustment circuit which generates a first input potential based on the potential for light emission and the predicted amount of current; an error amplifier which detects the difference between the first input potential and a reference potential determined corresponding to the potential for light emission; and an output control circuit which performs a control for suppressing the fluctuation of the potential for light emission based on the detected difference.

(5) In the image display device having the constitution described in (4), the feedback voltage adjustment circuit includes: a first resistor which has one end to which the potential for light emission is applied and inputs a potential at the other end thereof to the error amplifier as the first input potential; and a second resistor which has one end which is connected to the other end of the first resistor and the other end to which a ground potential is supplied, and magnitude of resistance with respect to one of the first resistor and the second resistor changes based on the predicted amount of current.

(6) In the image display device having the constitution described in (4), the feedback voltage adjustment circuit includes: a first resistor which has one end to which the potential for light emission is applied and inputs a potential at the other end thereof to the error amplifier as the first input potential; a second resistor which has one end which is connected to the other end of the first resistor and the other end to which a ground potential is supplied; and a resistance control switch and a third resistor which are arranged in series between one end of the first resistor and the other end of the first resistor, and the resistance control switch is controlled based on the predicted amount of current.

(7) In the image display device having the constitution described in (4), the feedback voltage adjustment circuit includes: a first resistor which has one end to which the potential for light emission is applied and inputs a potential at the other end thereof to the error amplifier as the first input potential; a second resistor which has one end which is connected to the other end of the first resistor and has the other end to which a ground potential is supplied; and a current source and a fourth resistor which are connected in series to the other end of the first resistor, and the feedback voltage adjustment circuit controls whether or not the current source flows a predetermined current based on the predicted amount of current.

(8) In the image display device having the constitution described in any one of (1) to (3), the power source part includes: a feedback voltage adjustment circuit which generates a first input potential obtained by dividing the potential for light emission; a reference voltage adjustment circuit which generates a second input potential based on the predicted amount of current; an error amplifier which detects the difference between the first input potential and the second input potential; and an output control circuit which performs a control of suppressing the fluctuation of the potential for light emission based on the detected difference.

(9) In the image display device having the constitution described in any one of (1) to (8), the image display device further includes a data line which has one end to which a display signal from the data line drive circuit is supplied, wherein the plural pixel circuits constitute a predetermined number of pixel rows, the data line drive circuit sequentially supplies the display signal to the pixel circuits belonging to each pixel row during a writing period, and supplies a light emitting control signal to the plural pixel circuits during a light emitting period after the writing period, and each of the pixel circuits includes: a storage capacitor which is provided between the data line and a gate electrode of the drive transistor; and a reset switch which is provided between a drain electrode and the gate electrode of the drive transistor and is turned on with the supply of the display signal to corresponding one of the pixel circuits.

(10) In the image display device having the constitution described in any one of (1) to (8), the image display device further includes: a data line which has one end to which a display signal from the data line drive circuit is supplied; and a light emitting control signal line, the plural pixel circuits constitute plural pixel rows, the data line drive circuit sequentially supplies the display signal to the pixel circuits belonging to each pixel row, and each of the pixel circuits includes: a pixel switch which has one end connected to the data line and is turned on with the supply of the display signal to the pixel circuit; a storage capacitor which is provided between a gate electrode of the drive transistor and the other end of the pixel switch; a light emitting control switch which is provided between the light emitting control signal line and the other end of the pixel switch and is turned on after the display signal is supplied; and a reset switch which is provided between a drain electrode and the gate electrode of the drive transistor and is turned on with the supply of the display signal to the pixel circuit.

According to the present invention, in the image display device, it is possible to suppress the fluctuation of a potential for light emission caused by a change in an amount of current which flows to the light emitting elements.

### BRIEF DESCRIPTION OF THE DRAWINGS

FIG. 1 is a view showing one example of the circuit constitution of an organic EL display device according to a first embodiment;

FIG. 2 is a view showing one example of the constitution of each of pixel circuits according to the first embodiment;

FIG. 3 is a waveform chart showing one example of a potential applied to a data line, a potential applied to a reset control line and a potential applied to a lighting control line;

FIG. 4 is a view showing one example of the constitution of a power source circuit according to the first embodiment;

FIG. 5 is a waveform chart showing a change with time of a potential of a gate electrode of a power source control switch, a potential of a drain electrode of the power source control switch, and a current which flows to an inductance when a light-emitting current which the power source circuit outputs is large;

FIG. 6 is a waveform chart showing a change with time of a potential of the gate electrode of the power source control switch, a potential of the drain electrode and a current which flows to the inductance when a light-emitting current which the power source circuit outputs is small;

FIG. 7 is a view showing the relationship between grayscale and brightness which image data exhibits;

FIG. 8 is a waveform chart showing one example of a potential for light emission, a light-emitting current which the power source circuit outputs, a converted potential which is obtained by conversion of a potential supplied to an error amplifier and a resistance value of a first resistor with respect to the power source circuit shown in FIG. 4;

FIG. 9 is a waveform chart showing one example of a potential for light emission, an amount of light-emitting current which a power source circuit outputs, and a potential of an error amplifier output when a conventional power source circuit is used;

FIG. 10 is a view showing another example of the constitution of the power source circuit according to the first embodiment;

FIG. 11 is a waveform chart showing one example of a potential for light emission, a light-emitting current which the power source circuit outputs, and a potential supplied to a gate electrode of a resistance control switch with respect to the power source circuit shown in FIG. 10;

FIG. 12 is a view showing another example of the constitution of the power source circuit according to the first embodiment;

FIG. 13 is a waveform chart showing one example of a potential for light emission, a light-emitting current which the power source circuit outputs, a potential which is supplied to the gate electrode of the resistance control switch, a signal which is used for controlling a current source, and an amount of current which flows from the current source with respect to the power source circuit shown in FIG. 12;

FIG. 14 is a view showing one example of the constitution of each pixel circuit according to a second embodiment;

FIG. 15 is a waveform chart showing one example of a potential applied to a data line, a potential applied to a reset control line and a potential applied to a lighting control line;

FIG. 16 is a view showing one example of a light-emitting current which the power source circuit outputs, a resistance value of the first resistor and a potential for light emission with respect to the power source circuit shown in FIG. 4;

FIG. 17 is a view showing another example of the power source circuit according to the second embodiment;

FIG. 18 is a view showing one example of a light-emitting current which the power source circuit outputs, a second input potential inputted to an error amplifier and a potential for light emission with respect to the power source circuit shown in FIG. 17; and

FIG. 19 is a view showing the constitution of a conventional power source circuit.

### DETAILED DESCRIPTION OF THE INVENTION

An image display device according to the present invention is explained in conjunction with embodiments using drawings. Out of constitutional elements which appear in the embodiments, the constitutional elements which have the identical function are given the same symbols and the repeated explanation of the constitutional elements is omitted. Hereinafter, the explanation is made with respect to a case where the present invention is applied to an organic EL display device which is one kind of an image display device using light emitting elements.

### First Embodiment

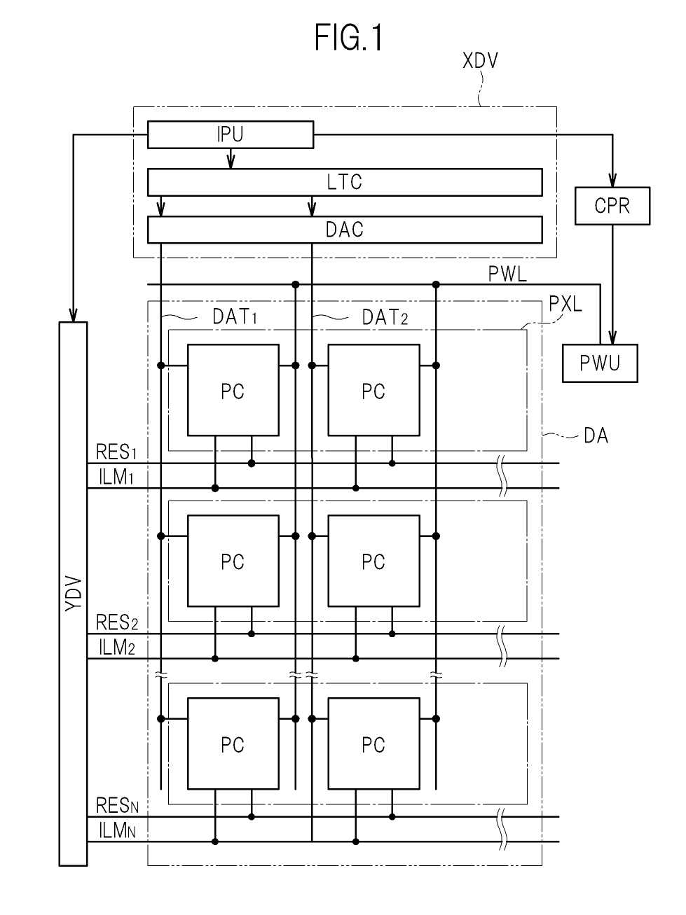

The organic EL display device physically includes an array substrate, a flexible printed circuit board, and a driver integrated circuit which is sealed in a package. A display region DA where an image is displayed is arranged on the array substrate. FIG. 1 shows one example of the circuit constitution of the organic EL display device according to the first embodiment. The circuit shown in FIG. 1 is mainly provided to the array substrate and the driver integrated circuit. The display region DA is provided above the array substrate of the organic EL display device, and pixel circuits PC are arranged in the display region DA in a matrix array. Assume that the organic EL display device performs a color display with resolution of M rows and N columns, ((3×M) columns×N rows) pieces of pixel circuits PC are arranged within a display region. Here, the row of pixel circuits PC is referred to as a pixel row PXL.

Within the display region DA, a data line DAT extends in the vertical direction in FIG. 1 corresponding to each column of pixel circuits PC, and a reset control line RES and a lighting control line ILM extend in the lateral direction in FIG. 1 corresponding to each row of pixel circuits PC. Hereinafter, the data line DAT corresponding to the column of pixel circuits PC on the mth column is indicated by DATₘ. One end of each data line DAT is connected to a data line drive circuit XDV, and a display signal is supplied to one end of each data line DAT from the data line drive circuit XDV. The number of reset control lines RES and the number of lighting control lines ILM are respectively equal to the number of rows of pixel circuits PC (N). The reset control line RES corresponding to the row of pixel circuits PC in the nth row is indicated by RESₙ, and the lighting control line ILM corresponding to the row of pixel circuits PC in the nth row is indicated by ILMₙ. One end of each reset control line RES and one end of each lighting control line ILM are connected to a vertical scanning circuit YDV.

Each pixel circuit PC is connected to a power source line PWL. In a region which falls within a region of the array substrate and outside the display region DA, the data line drive circuit XDV, the vertical scanning circuit YDV, a current amount prediction part CPR and a power source circuit PWU are provided. Parts of these circuits are also provided in the driver integrated circuit.

The data line drive circuit XDV includes an image data processing part IPU, a latch circuit LTC and a digital/analog converter DAC. The image data processing part IPU acquires image data for display, calculates and outputs grayscale data indicative of a value of a potential of a display signal, and also outputs a clock signal and a synchronizing signal for controlling signals outputted through the reset control line RES and the lighting control line ILM. The latch circuit LTC stores grayscale data with respect to one row which is sequentially transmitted from the image data processing part IPU. The digital/analog converter DAC generates a display signal corresponding to the grayscale data stored in the latch circuit LTC, and outputs the display signal to the data line DAT.

Image data is inputted to the current amount prediction part CPR from the image data processing part IPU, and the current amount prediction part CPR predicts an amount of current which flows to the power source line PWL. Prediction current amount data CPD which is a signal indicative of the predicted amount of current is inputted to the power source circuit PWU. The manner of operation of the image data processing part IPU, the current amount prediction part CPR and the power source circuit PWU is explained later.

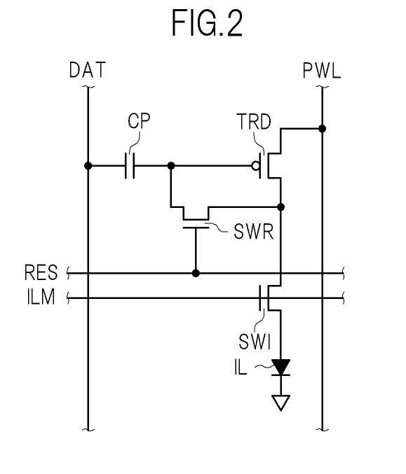

FIG. 2 is a view showing one example of the constitution of each of the pixel circuits PC of the organic EL display device according to the first embodiment. Each of the pixel circuits PC includes a light emitting element IL, a drive transistor TRD, a storage capacitor CP, a lighting control switch SWI and a reset switch SWR. A cathode of the light emitting element IL is connected to a ground potential supply line not shown in the drawing. A ground potential is supplied through the ground potential supply line. The drive transistor TRD has a gate electrode, a source electrode and a drain electrode. In this embodiment, the ground potential is a potential which is determined based on the relative relationship among a light-emitting potential Voled supplied through the power source line PWL for light emission, a potential supplied to the data line DAT, a potential used for operating a switch such as the lighting control switch SWI, a potential supplied to the gate electrode of the drive transistor TRD and the like. The ground potential may not be always supplied from a grounded electrode.

The drive transistor TRD is a p-channel type thin film transistor, and controls an amount of current which flows to the light emitting element IL corresponding to the potential difference between a potential applied to the gate electrode and a potential applied to the source electrode. The source electrode of the drive transistor TRD is connected to the power source line PWL, and the drain electrode of the drive transistor TRD is connected to an anode of the light emitting element IL via the lighting control switch SWI. One end of the storage capacitor CP is connected to the gate electrode of the drive transistor TRD. The other end of the storage capacitor CP is connected to the data line DAT. One end of the reset switch SWR is connected to the gate electrode of the drive transistor TRD, and the other end of the reset switch SWR is connected to the drain electrode of the drive transistor TRD. The light emitting element IL is an organic EL element, and is also referred to as an OLED (organic light-emitting diode) since the light emitting element IL generally possesses diode characteristic. The lighting control switch SWI and the reset switch SWR are formed of an n-channel-type thin film transistor. A gate electrode of the reset switch SWR is connected to the reset control line RES, and a gate electrode of the lighting control switch SWI is connected to the lighting control line ILM.

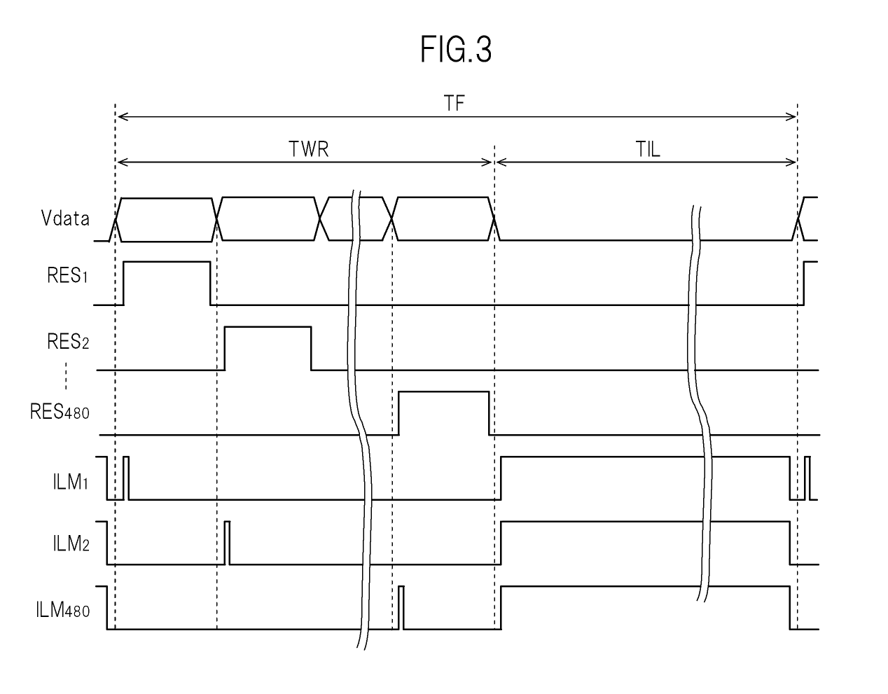

Next, a driving method of the organic EL display device according to this embodiment is explained. FIG. 3 is a waveform chart showing one example of a potential applied to the data line DAT, a potential applied to the reset control line RES and a potential applied to the lighting control line ILM. The explanation is made hereinafter with respect to a case where N is 480. In this embodiment, one field period TF is divided into a writing period TWR which is a period in which a display signal is sequentially written in the pixel circuits PC included in each pixel row PXL, and a light emitting period TIL which is a period succeeding the writing period TWR and is a period in which a light emitting control signal is supplied to the respective pixel circuits PC. At a point of time that the writing period TWR starts, a potential of the reset control line RES in each row is at a Low level, and a potential of the lighting control line ILM in each row is also at a Low level. Accordingly, both the reset switch SWR and the lighting control switch SWI in each pixel circuit PC are turned off. In the writing period TWR, firstly, a display signal which is written in the pixel circuit PC in the first row as a potential Vdata of the data line DAT is supplied. Next, a potential of the reset control line RES₁ in the first row and a potential of the lighting control line ILM₁ in the first row assume a High level so that the reset switch SWR and the lighting control switch SWI of the pixel circuit PC included in the first pixel row PXL are turned on. As a result, one end of the storage capacitor CP included in the pixel circuit PC is connected to the ground potential supply line via the light emitting element IL, and a charge stored in the storage capacitor CP is reset. When time necessary for substantially resetting the charge elapses, the potential of the lighting control line ILM in the first row becomes a Low level so that the lighting control switch SWI is turned off. The elapsed time is sufficiently small compared to the period in which a writing operation is applied to this row and the light emitting period TIL. At timing that the lighting control switch SWI is turned off, a so-called diode connection state where the gate electrode and the drain electrode of the drive transistor TRD are connected to each other is brought about and hence, a current flows to the storage capacitor CP from the power source line PWL through the drive transistor TRD until the potential difference between a potential of the gate electrode and a potential of the source electrode becomes a threshold voltage Vth of the drive transistor TRD.

When the current which flows to the storage capacitor CP becomes sufficiently small, there arises a state where a potential obtained by subtracting the threshold voltage Vth of the drive transistor from the light-emitting potential Voled is supplied to one end of the storage capacitor CP. Assuming a potential of a display signal supplied to the other end of the storage capacitor CP from the data line DAT as Vdp, the potential difference stored in the storage capacitor CP becomes (Voled−|Vth|−Vdp). Then, a potential of the reset control line RES in the first row becomes a Low level so that the reset switch SWR is turned off. These operations are repeated also with respect to the pixel row PXL in the second row and the pixel rows PXL in rows succeeding the second row.

After the writing operation is performed up to Nth (=480th) row, the light emitting period TIL starts subsequently. In the light emitting period TIL, a potential Vic of a light emitting control signal is supplied to each data line DAT so that a potential of each lighting control line ILM becomes High level whereby the lighting control switch included in each pixel circuit PC is turned on. As a result, a gate-source voltage of the drive transistor TRD becomes (−|Vth|−Vdp+Vic) so that the threshold voltage Vth of the drive transistor TRD included in each pixel circuit PC is cancelled in condition that the light-emitting potential Voled at the timing when the display signal is written in the pixel circuit PC is equal to the light-emitting potential Voled at the timing of light emitting. Accordingly, an amount of current which is supplied to the light emitting element IL is determined in accordance with a display signal and the amount of current is irrespective of a magnitude of the threshold voltage Vth.

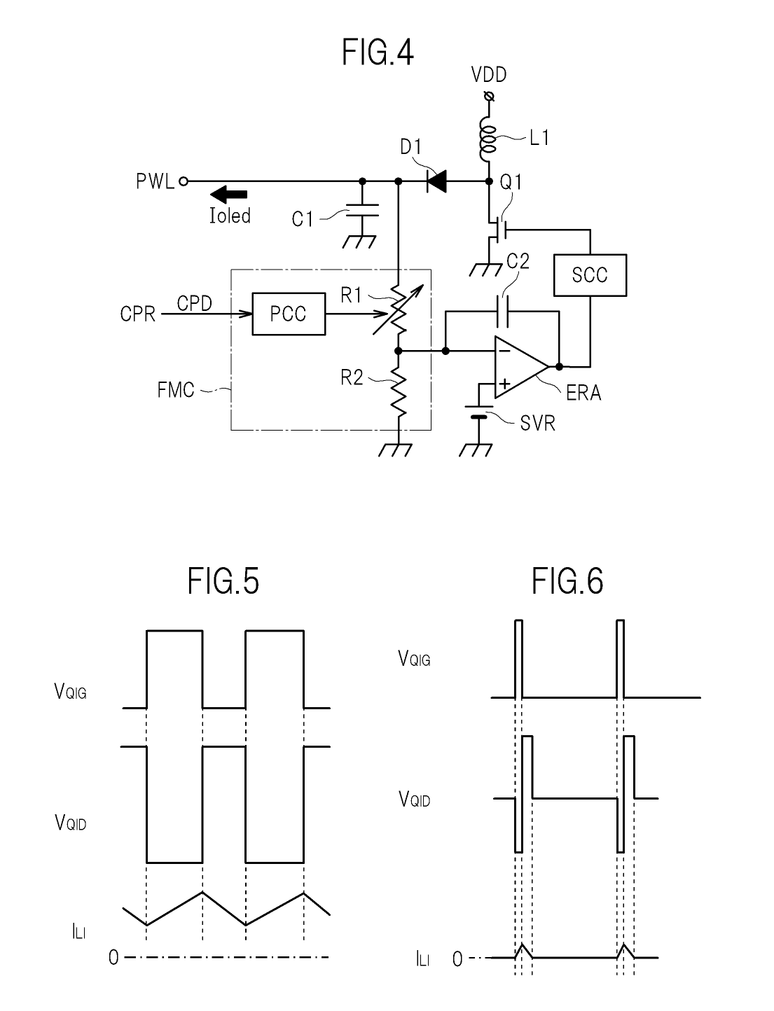

FIG. 4 shows one example of the constitution of the power source circuit PWU according to the first embodiment. The power source circuit PWU shown in FIG. 4 includes a power source input terminal to which a power source potential VDD is applied, an inductance L1, a power source control switch Q1, a diode D1, a first resistor R1, a second resistor R2, a stabilization capacitor C1, an error amplifier ERA, an integration capacitor C2, a reference voltage source SVR, a power source control switch control circuit SCC, and an error amplifier input control part PCC. One end of the inductance L1 is connected to the power source input terminal, and an anode of the diode D1 and one end of the power source control switch Q1 are connected to the other end of the inductance L1. A ground potential is supplied to the other end of the power source control switch Q1. Here, the power source control switch Q1 is a field effect transistor. A cathode of the diode D1 is connected to a first end of the stabilization capacitor C1, and a ground potential is supplied to a second end of the stabilization capacitor C1. Also one end of the first resistor R1 is connected to the first end of the stabilization capacitor C1, the second resistor R2 is connected to the other end of the first resistor R1, and the ground potential is supplied to the other end of the second resistor R2. The first resistor R1 is a variable resistor. The error amplifier ERA includes a first input terminal, a second input terminal and an output terminal, and the integration capacitor C2 is provided between the first input terminal and the output terminal. Due to such a constitution, the error amplifier ERA and the integration capacitor C2 are operated as an integrator circuit. The first input terminal of the error amplifier ERA is connected to the other end of the first resistor R1, the second input terminal of the error amplifier ERA is connected to the reference voltage source SVR, and the output terminal is connected to the power source control switch control circuit SCC. The first resistor R1, the second resistor R2 and the error amplifier input control part PCC adjust a feedback voltage to the error amplifier ERA and hence, these parts are collectively referred to as a feedback voltage adjustment circuit FMC. Further, the power source control switch control circuit SCC is connected to a gate electrode of the power source control switch Q1. The first end of the stabilization capacitor C1 is also connected to the power source line PWL, and a potential at the first end of the stabilization capacitor C1 is supplied to the power source line PWL as the light-emitting potential Voled. An amount of current supplied to the power source line PWL is referred to as Ioled. The power source circuit PWU is a kind of so-called switching regulator.

The basic operation of the power source circuit PWU is explained. The error amplifier ERA outputs an error amplifier output Verr to the power source control switch control circuit SCC. The error amplifier output Verr is a voltage corresponding to an integrated value of difference between a potential applied to the first input terminal based on a light-emitting potential and a reference potential which the reference voltage source SVR applies to the second input terminal. The power source control switch control circuit SCC performs a PWM control based on the error amplifier output Verr thus performing an ON operation or an OFF operation of the power source control switch Q1. A potential higher than the power source potential VDD is generated at the other end of the inductance L1 when the power source control switch Q1 is turned off. A current which flows to the stabilization capacitor C1 from the inductance L1 through the diode D1 is generated due to such a potential and a charge is stored in the stabilization capacitor C1. The light-emitting potential Voled which is lowered to some extent rises again due to the supply of such a current.

FIG. 5 and FIG. 6 are waveform charts showing a change with time of a potential V_{Q1G} of the gate electrode of the power source control switch Q1, a potential V_{Q1D} of the drain electrode of the power source control switch Q1 and a current I_{L1} which flows to the inductance L1. FIG. 5 is the waveform chart when an amount of current which the power source circuit outputs is large (a case where a value of the error amplifier output Verr indicates that a lowering amount of a light-emitting potential is large), and FIG. 6 is the waveform chart when an amount of current which the power source circuit outputs is small (a case where the value of the error amplifier output Verr indicates that the lowering amount of the light-emitting potential is small). When the potential V_{Q1G} of the gate electrode of the power source control switch Q1 becomes a High level so that a time during which the power source control switch Q1 assumes an ON state is prolonged, an amount of current I_{L1} is increased by an amount corresponding to the elongated ON time. In response to a high potential generated by the inductance L1 when the power source control switch Q1 is turned off, an amount of current which flows to the stabilization capacitor C1 through the diode D1 is also increased. The power source control switch control circuit SCC controls a time during which the power source control switch Q1 assumes an ON state based on a PWM control. A control method of the power source control switch control circuit SCC is not limited to such a PWM control, and may be other methods such as a method which changes frequency for opening or closing the power source control switch Q1.

A first input potential applied to the first input terminal of the error amplifier ERA is generated based on predicted current amount data CPD inputted to the feedback voltage adjustment circuit FMC from the current amount prediction part CPR. The detail of this operation is described later.

Next, steps of generating the predicted current amount data CPD from image data are explained. The current amount prediction part CPR predicts an amount of current which flows to the plural pixel circuits PC from the power source circuit PWU through the power source line PWL when the light emitting elements IL included in the respective pixel circuits PC emit lights corresponding to the image data based on image data indicative of grayscale of the respective pixels on one frame. The grayscale of each of the pixels is expressed by digital values, and the values of the grayscale range from 0 to 255 in case of 256 levels, for example. Amounts of currents which flow to the light emitting elements IL included in the respective pixel circuits PC are calculated based on the image data, and a value which is obtained by summing up the amounts of currents corresponding to 1 frame is set as a value of a predicted amount of current. The value of the predicted amount of current is outputted as the predicted current amount data CPD.

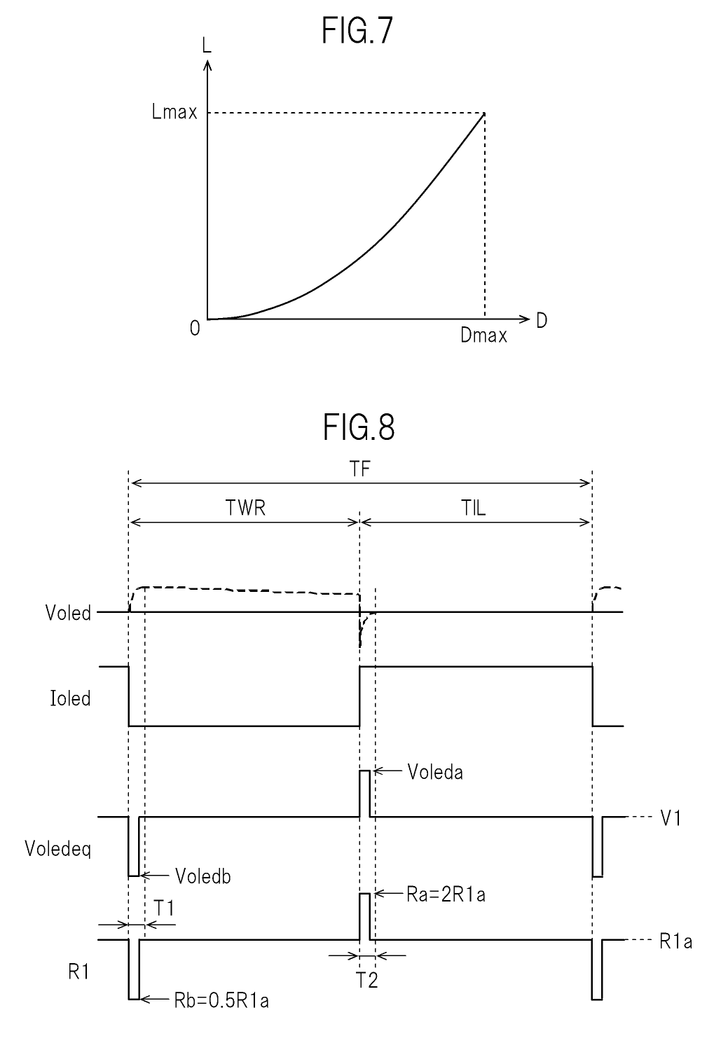

FIG. 7 is a view showing the relationship between grayscale and brightness which image data shows. A value of brightness in a certain pixel is proportional to 2.2th power of the grayscale. That is, assuming the maximum brightness at maximum grayscale Dmax as Lmax, the brightness L at a certain grayscale D can be calculated by a formula L=Lmax×(D/Dmax)^{2.2}. On the other hand, the relationship between the brightness L and an amount of current which flows to the light emitting element IL is generally the proportional relationship. Thus, assuming an amount of current which flows to the light emitting element at the maximum grayscale Dmax as Imax, an amount of current I which flows to the light emitting element IL at the certain grayscale D can be calculated by a formula I=Imax×(D/Dmax)^{2.2}. In this embodiment, the current amount prediction part CPR includes a total result storage memory which stores a total result of amounts of current calculated with respect to image data for a certain field period TF, and the current amount prediction part CPR resets a value of the total result storage memory when the current amount prediction part CPR receives a value of grayscale of the first pixel of the frame in a certain field from the image data processing part IPU. The current amount prediction part CPR repeats the following calculation process and addition process with respect to image data of an image to be displayed during the field period TF. The calculation process is calculation of an amount of current which flows to the light emitting element IL included in each pixel circuit using the above-mentioned formula based on a value of grayscale sequentially supplied for every pixel from the image data processing part IPU. The addition process contains process in which the value of the amount of current is added to the value stored in the total result storage memory and process in which the obtained value added with the value of the amount of current is stored in the total result storage memory again. The current amount prediction part CPR predicts an amount of current which flows to the power source line PWL during the light emitting period TIL in this manner. The predicted current amount data CPD is a value of such a predicted amount of current, and is a value stored in the total result storage memory at a point of time that repeated processing for 1 frame is finished.

Next, the operation of the error amplifier input control part PCC and the first resistor R1 based on the predicted current amount data CPD is explained. The error amplifier input control part PCC has a lookup table corresponding to the combination of a predicted amount of current in the previous field period TF and a predicted amount of current in the present field period TF. In the lookup table, information such as a period during which a resistance value of the first resistor R1 is changed, a change amount of the resistance value, and timing at which a change starts or finishes is stored. Information in the lookup table is information which is determined based on experiments or by calculation in advance. The error amplifier input control part PCC acquires an amount of change in the resistance value of the first resistor R1 and timing of changing the resistance value corresponding to the predicted current amount data using the lookup table, and controls the resistance value of the first resistor R1.

FIG. 8 is a waveform chart showing one example of a change in the light-emitting potential Voled, a light-emitting current Ioled which the power source circuit PWU outputs, a converted potential Voledeq which is obtained by conversion of a potential supplied to the error amplifier ERA and a resistance value of the first resistor R1 with respect to the power source circuit shown in FIG. 4. Firstly, a first input potential Vei1 inputted to the first input terminal is obtained by division of potential using the first resistor and the second resistor and hence, the first input potential Vei1 can be calculated by a following formula.

Vei1=R2/(R1+R2)×Voled

A second input potential inputted to the second input terminal of the error amplifier ERA is a reference potential Vref which the reference voltage source outputs. Hereinafter, a control of the power source circuit PWU is explained using a potential at which the light-emitting potential Voled is expected to arrive (hereinafter referred to as the converted potential Voledeq). Firstly, the converted potential Voledeq is the light-emitting potential Voled when the first input potential and the second input potential which are inputted to the error amplifier ERA are equal, and is calculated using the following formula.

Voledeq=(R1+R2)/R2×Vref

In this formula, R1 indicates a resistance value of the first resistor R1 and R2 indicates a resistance value of the second resistor R2. On the other hand, when the writing period TWR and the light emitting period TIL are separate as shown in FIG. 3, an amount of the light-emitting current baled which flows during the writing period TWR and an amount of the light-emitting current Ioled which flows during the light emitting period TIL differ from each other and hence, a waveform of the amount of light-emitting current Ioled which the power source circuit outputs becomes a square wave. In this case, firstly, when the light emitting operation in the light emitting period TIL is shifted to the writing operation in the writing period TWR, an amount of light-emitting current Ioled which flows from the power source circuit PWU rapidly changes (in this case, an amount of light-emitting current Ioled becomes 0). Here, the error amplifier input control part PCC performs a control such that a resistance value of the first resistor R1 becomes small in a period T1 at the beginning of the writing period TWR after a point of time that the light emitting period TIL is finished. With respect to the light-emitting potential Voled, a potential which is to be supplied and is set in advance is defined as a target potential V1. A resistance value of the first resistor when the light-emitting potential Voled becomes the target potential V1 and the first input potential becomes equal to the reference potential Vref is set as R1a. Assuming that Voledb is a value of the converted potential Voledeq when the resistance value of the first resistor R1 during the period T1 is Rb which satisfies Rb=0.5R1a, the value of the converted potential Voledb is expressed by a following formula.

Voledb=(0.5R1a+R2)/R2×Vref

Accordingly, the converted potential Voledeq at which the light-emitting potential Voled is expected to arrive becomes smaller than an original target potential and hence, the error amplifier ERA outputs the error amplifier output Verr so as to rapidly lower the light-emitting potential Voled. Then, the error amplifier input control part PCC responds to the error amplifier output Verr, and rapidly narrows an ON period of the power source control switch Q1. Accordingly, an amount of current which is supplied at the beginning of the writing period TWR is suppressed compared to a case where the resistance value of the first resistor R1 is not controlled and hence, a voltage ripple in a positive direction which may be generated when the light emitting period TIL is shifted to the writing period TWR can be also suppressed.

Next, the operation during a period T2 at the beginning of the light emitting period TIL after a point of time that the writing period TWR is finished is explained. During the period T2, a control is performed such that the resistance value of the first resistor R1 is increased. Assuming that Voleda is the converted potential Voledeq when the resistance value of the first resistor R1 during the period T2 is Ra which satisfy Ra=2R1a, A value Voleda is expressed by the following formula.

Voleda=(2R1a+P2)/R2×Vref

Accordingly, the converted potential Voledeq at which the light-emitting potential Voled is expected to arrive becomes larger than the original target potential and hence, the error amplifier ERA outputs the error amplifier output Verr which makes the light-emitting potential Voled rise rapidly. The error amplifier input control part PCC responds to the error amplifier output Verr, and rapidly expands an ON period of the power source control switch Q1. Accordingly, an amount of current which is supplied at the beginning of the light emitting period TIL becomes large compared to a case where the resistance value of the first resistor P1 is not controlled and hence, a voltage ripple in a negative direction which is generated when the writing period TWR is shifted to the light emitting period TIL can be also suppressed.

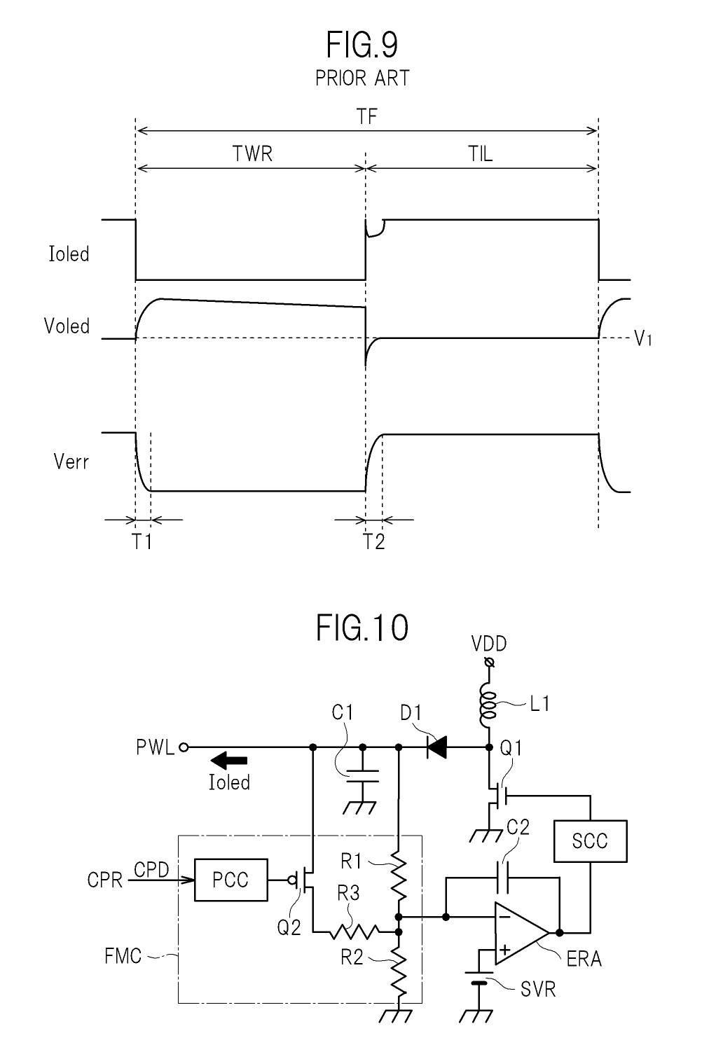

This advantage becomes more apparent compared to a case where a conventional power source circuit is used. FIG. 9 is a waveform chart showing one example of a light-emitting potential, an amount of current which a power source circuit outputs, and a potential of the error amplifier output Verr when the conventional power source circuit is used. When the first input potential is not changed, hence, the error amplifier output Verr changes slowly compared to this embodiment. When the light emitting period TIL is shifted to the writing period TWR, a charge more than necessity is stored in the stabilization capacitor C1 of the power source circuit PWU and hence, the light-emitting potential Voled largely exceeds the target potential V1 for a feedback control. Even after such an operation, a current which flows to the pixel circuit PC from the power source line PWL is small and hence, the light-emitting potential Voled is only gradually lowered and does not return to the target potential V1. Accordingly, the light-emitting potential changes during the writing period TWR and hence, the manner of cancelling the threshold voltage Vth of the drive transistor TRD changes for every row of pixel circuits PC and the change is recognized as brightness irregularities on a screen. Further, when the writing period TWR is switched to the light emitting period TIL, the supply of a charge to the stabilization capacitor C1 cannot catch up with the charge variation and hence, the light-emitting potential Voled is lowered.

In this embodiment, changing of a resistance value of the first resistor may be started after the emission of light from the light emitting element IL is finished in the light emitting period TIL and before the writing period TWR starts, or the adjustment of the resistance value may be started after the writing in each pixel row PXL is finished and before the light emitting period TIL starts. With such operations, a change in the light-emitting potential Voled during the writing period TWR or at the beginning of the light emitting period TIL can be further suppressed.

In the power source circuit PWU shown in FIG. 4, a first input potential is changed by changing a resistance value of the first resistor R1 in accordance with a predicted amount of current. However, the first input potential may be changed by other methods. FIG. 10 shows another example of the constitution of the power source circuit PWU according to the first embodiment. The power source circuit PWU shown in FIG. 10 differs from the power source circuit PWU shown in FIG. 4 with respect to following two points. One point is that the power source circuit PWU includes a resistance control switch Q2 which is serially connected between one end and the other end of the first resistor. Another point is that the first resistor R1 is not a variable resistor, and the error amplifier input control part PCC controls the resistance control switch Q2. The resistance control switch Q2 is formed of a p-channel-type thin film transistor.

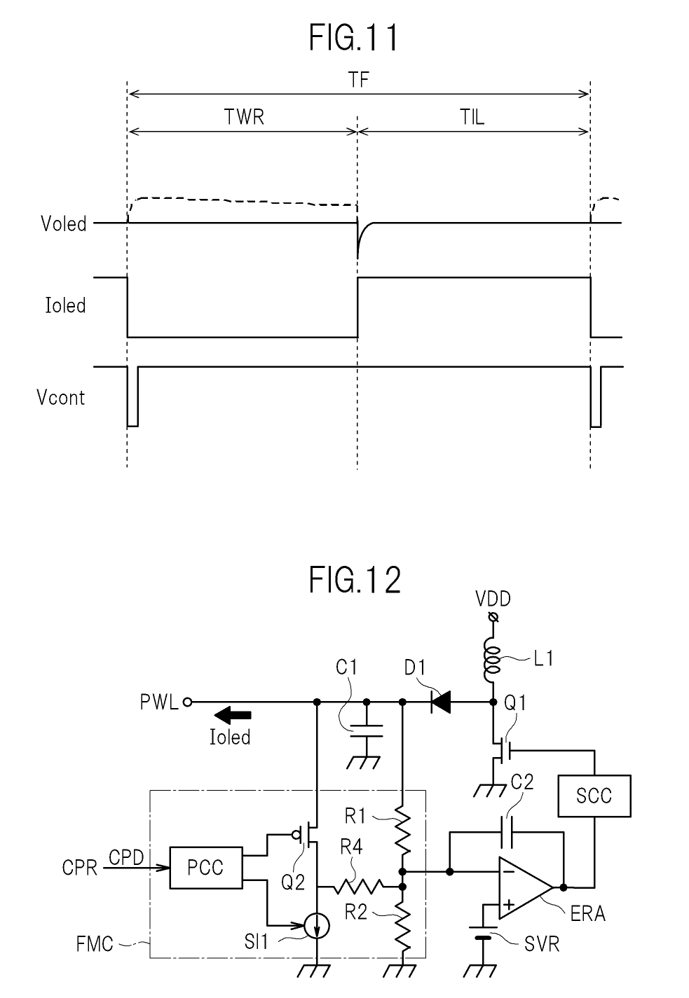

FIG. 11 is a waveform chart showing one example of the light-emitting potential Voled, the light-emitting current Ioled which the power source circuit PWU outputs, and a potential Vcont supplied to a gate electrode of the resistance control switch Q2 with respect to the power source circuit PWU shown in FIG. 10. In the example shown in FIG. 11, within a predetermined period from a point of time that the light emitting period TIL is switched to the writing period TWR, the gate electrode of the resistance control switch Q2 becomes a Low level so that the resistance control switch Q2 is turned on. When the resistance control switch Q2 is turned on, the first resistor R1 and a third resistor R3 are connected to each other in parallel and hence, the converted potential Voledeq is expressed by the following formula.

Voledeq=[(R1×R3)/(R1+R3)+R2]/R2×Vref

Here, R3 in the formula indicates a resistance value of the third resistor R3. As can be understood from the formula, the value of the converted potential Voledeq becomes smaller than the target potential V1 and hence, in the same manner as the case where the resistance value of the first resistor R1 is reduced in the power source circuit PWU shown in FIG. 4, a voltage ripple in a positive direction when the light emitting period TIL is shifted to the writing period TWR can be suppressed. Accordingly, a change in the light-emitting potential Voled during the writing period TWR can be suppressed and hence, brightness irregularities on a screen can be suppressed. Further, the suppression effect is obtained only by a timing control of a switching operation of the resistance control switch Q2 and hence, data to be stored in the lookup table in the error amplifier input control part PCC can be decreased whereby a circuit scale of the error amplifier input control part PCC can be made small compared to the example shown in FIG. 4.

FIG. 12 shows another example of the constitution of the power source circuit PWU according to the first embodiment. As shown in FIG. 12, this example is characterized in that the first input potential is controlled using a current source SI1 and a fourth resistor R4. The error amplifier input control part PCC controls whether or not the current source SI1 flows a current.

To be more specific, the power source circuit PWU shown in FIG. 12 differs from the power source circuit PWU shown in FIG. 4 with respect to the following points. One point is that the power source circuit PWU includes the fourth resistor R4, the resistance control switch Q2 and the current source SI1. One end of the fourth resistor R4 is connected to one end of the first resistor R1 on a side where the first resistor R1 is connected to the first input terminal. The resistance control switch Q2 is provided between the other end of the fourth resistor R4 and the other end of the first resistor R1. The current source SI1 is provided between the other end of the fourth resistor R4 and a ground potential supply line. Another point is that the first resistor R1 is not a variable resistor, and the error amplifier input control part PCC controls the resistance control switch Q2 and the current source SI1. The resistance control switch Q2 is formed of a p-channel-type thin film transistor.

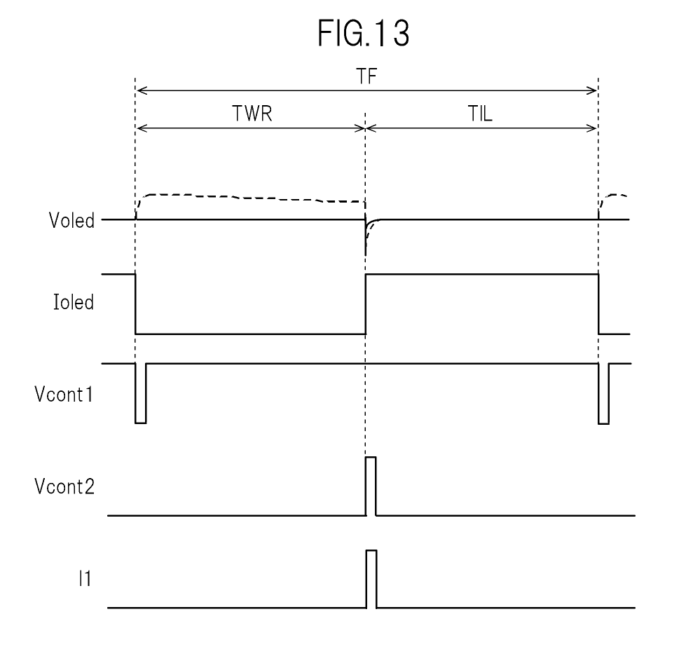

FIG. 13 is a waveform chart showing one example of the light-emitting potential Voled, the light-emitting current Ioled which the power source circuit outputs, a potential Vcont1 which is supplied to a gate electrode of the resistance control switch Q2, a signal Vcont2 which is used for controlling the current source SI1, and an amount of current I1 which flows from the current source SI1 with respect to the power source circuit PWU shown in FIG. 12. In the example shown in FIG. 13, within a predetermined period from a point of time that the light emitting period TIL is switched to the writing period TWR, the gate electrode of the resistance control switch Q2 becomes a Low level so that the resistance control switch Q2 is turned on. When the resistance control switch Q2 is turned on, the first resistor R1 and the fourth resistor R4 are connected to each other in parallel and hence, in the same manner as the example explained in conjunction with FIG. 11, it is possible to acquire an advantageous effect that a voltage ripple in a positive direction when the light emitting period TIL is shifted to the writing period TWR can be suppressed.

On the other hand, during a predetermined period from a point of time that the writing period TWR is shifted to the light emitting period TIL, a potential of the signal Vcont2 for controlling the current source SI1 becomes a High level, and the current source SI1 supplies a predetermined amount of current I1 during a period that the potential of the signal Vcont2 is at a High level. Here, a value of a first input potential inputted to the error amplifier ERA is expressed by I1×(a resistance value of the fourth resistor R4). By deciding a value of the predetermined amount of current I1 such that the first input potential is sufficiently smaller than the reference potential Vref, the error amplifier ERA outputs the error amplifier output Verr which makes the light-emitting potential Voled rise rapidly during this period. Accordingly, an amount of current which is supplied at the beginning of the light emitting period TIL becomes larger than an amount of current in a case where this constitution is not adopted and hence, a voltage ripple in a negative direction when the writing period TWR is shifted to the light emitting period TIL can be suppressed.

### Second Embodiment

The second embodiment relates to a case where the light emitting period TIL starts immediately after a writing operation of a display signal to pixel circuits PC included in each pixel row PXL is finished, and start timing and finish timing of the light emitting period TIL differ for every pixel row PXL. Hereinafter, this embodiment is explained by focusing on points where this embodiment differs from the first embodiment.

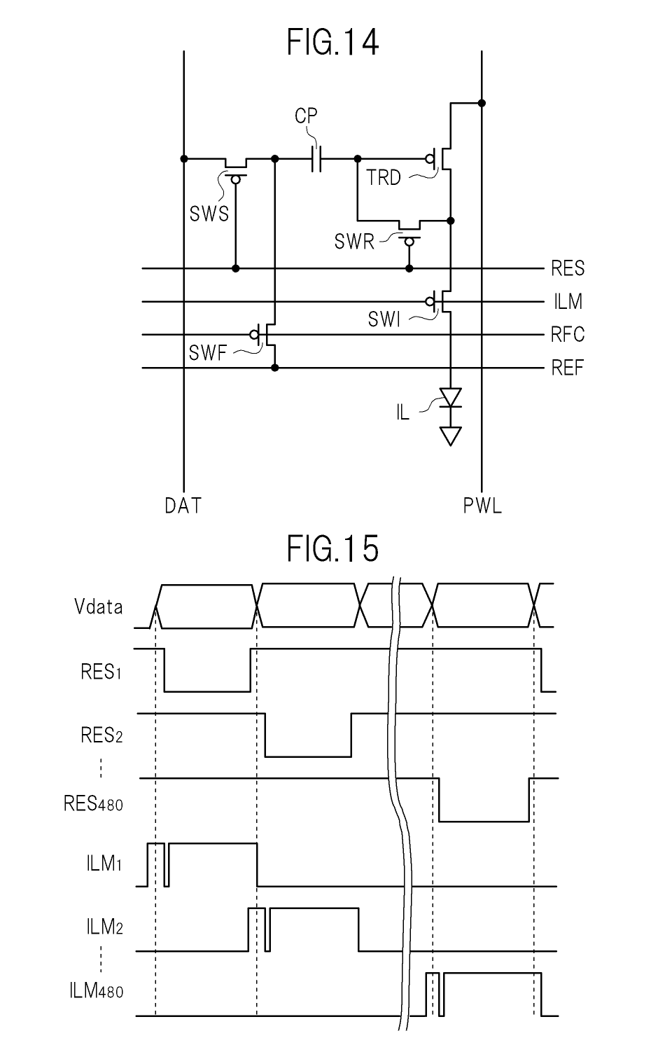

FIG. 14 is a view showing one example of the constitution of each pixel circuit PC of an organic EL display device according to the second embodiment. Each pixel circuit PC includes a light emitting element IL, a drive transistor TRD, a storage capacitor CP, a lighting control switch SWI, a reset switch SWR, a data line input switch SWS, and a light emitting signal input switch SWF. A cathode of the light emitting element IL is connected to a ground potential supply line not shown in the drawing. The drive transistor TRD is a p-channel type thin film transistor, and controls an amount of current which flows to the light emitting element IL in accordance with the potential difference between a potential applied to the gate electrode and a potential applied to the source electrode. The source electrode of the drive transistor TRD is connected to the power source line PWL, and a drain electrode of the drive transistor TRD is connected to an anode of the light emitting element IL via the lighting control switch SWI. One end of the storage capacitor CP is connected to the gate electrode of the drive transistor TRD, and the other end of the storage capacitor CP is connected to the data line DAT via the data line input switch SWS. Further, the other end of the storage capacitor CP is connected to a light emitting control signal line REF via the light emitting signal input switch SWF. One end of the reset switch SWR is connected to the gate electrode of the drive transistor TRD, and the other end of the reset switch SWR is connected to the drain electrode of the drive transistor TRD. The lighting control switch SWI, the reset switch SWR, the data line input switch SWS and the light emitting signal input switch SWF are formed of an p-channel-type thin film transistor.

Gate electrodes of the reset switch SWR and the data line input switch SWS are connected to the reset control line RES, and a gate electrode of the light emitting signal input switch SWF is connected to a light emitting control signal control line RFC. Here, the number of the light emitting control signal control lines RFC and the number of the light emitting control signal lines REF are N respectively, and these lines are provided corresponding to the respective pixel rows PXL. One end of each light emitting control signal control line RFC and one end of each light emitting control signal line REF are connected to the vertical scanning circuit YDV.

Next, the method of driving the organic EL display device according to this embodiment is explained. FIG. 15 is a waveform chart showing one example of a potential applied to the data line DAT, a potential applied to the reset control line RES and a potential applied to the lighting control line ILM. In this embodiment, a display signal is written in the pixel circuits PC sequentially from the pixel circuits PC in the first row, and when writing of a display signal in the pixel circuits PC in the 480th row is finished, writing of a display signal is performed sequentially from the pixel circuits PC in the first row through a vertical blanking period. Further, the light emitting elements IL included in the pixel circuits PC emit light with brightness corresponding to the display signal in writing a display signal in the pixel circuits PC in another row. Accordingly, in this embodiment, the different pixel row PXL has the different start timing and finish timing with respect to the writing period TWR and the light emitting period TIL. Here, in this embodiment, a period from a point of time that the writing period TWR for the pixel circuits PC in the first row starts to a point of time that the writing period TWR for the pixel circuits PC in the first row starts again is referred to as a field period TF.

To be more specific, before the writing period TWR for writing a display signal in the pixel circuits PC included in a first pixel row PXL1 starts, a potential of a lighting control line ILM₁ becomes a High level so that the lighting control switch SWI is turned off whereby the emission of light emitting element IL stops. When the writing period TWR starts, a potential of a reset control line RES₁ becomes a Low level and the potential of the lighting control line ILM₁ becomes a Low level so that the reset switch SWR, the data line input switch SWS and the lighting control switch SWI are turned on. As a result, one end of the storage capacitor CP is connected to the ground potential supply line via the light emitting element IL and hence, a charge stored in the storage capacitor CP is reset. When a time necessary for substantially resetting the charge elapses, a potential of the lighting control line ILM₁ becomes a High level so that the lighting control switch SWI is turned off. Since the drive transistor TRD is brought into the diode connection and the potential Vdp of a display signal is supplied from the data line DAT at this timing, the potential difference of (Voled−|Vth|−Vdp) is stored in the memory capacitor CP before the writing period TWR is finished. Then, a potential of the reset control line RES₁ becomes a High level so that the reset switch SWR is turned off. Thereafter, the light emitting period TIL of this row starts so that a potential of the lighting control line ILM₁ becomes a Low level and a potential of a light emitting control signal control line RFC₁ becomes a Low level. As a result, the potential Vic of a light emitting control signal is supplied to the other end of the storage capacitor CP. A gate-source voltage of the drive transistor TRD becomes (−|Vth|−Vdp+Vic) in condition that a value of the light-emitting potential Voled is equal between timing at which a display signal is written in the pixel circuit PC and light emitting timing, thus an amount of current which is supplied to the light emitting element IL reflects the cancellation of the threshold voltage Vth of the drive transistor TRD included in each pixel circuit PC. Accordingly, the light emitting element IL emits light in response to a display signal. The writing period TWR of the second pixel row PXL starts at a point of time that the light emitting period TIL of the first pixel row PXL starts. The display signal writing operation and the light emitting operation are performed in the same manner with respect to the pixel circuits PC in the second row and rows succeeding the second row.

With respect to the circuit constitution of the power source circuit PWU, the circuit constitution explained in conjunction with the first embodiment may be used. Hereinafter, the case where the power source circuit PWU shown in FIG. 4 is used is explained. In this embodiment, the start timing of the light emitting period TIL differs for every row and hence, the light-emitting current Ioled does not rapidly change compared to the first embodiment. However, a change in light-emitting current Ioled occurs in such a case where the brightness differs between the row where the light emitting period TIL starts and the row where the light emitting period TIL is finished. With the use of the power source circuit PWU, the fluctuation of the light-emitting potential Voled caused by a change in the light-emitting current Ioled can be suppressed.

With respect to the light-emitting current Ioled, steps where the current amount prediction part CPR generates the predicted current amount data CPD from image data are explained. Image data is inputted to the current amount prediction part CPR in the same manner as the first embodiment, and an amount of current which flows to the light emitting element IL included in the respective pixel circuits PC is calculated in the same method as the first embodiment. Here, the current amount prediction part CPR includes a current amount prediction result storage memory for every row. A value which is obtained by integrating predicted amounts of current calculated with respect to the pixel circuits PC in the corresponding row is stored in the current amount prediction result storage memory. A result obtained by integrating contents of the current amount prediction result storage memories corresponding to rows other than the row where the writing period TWR comes next is outputted as the predicted current amount data CPD for every 1 horizontal period.

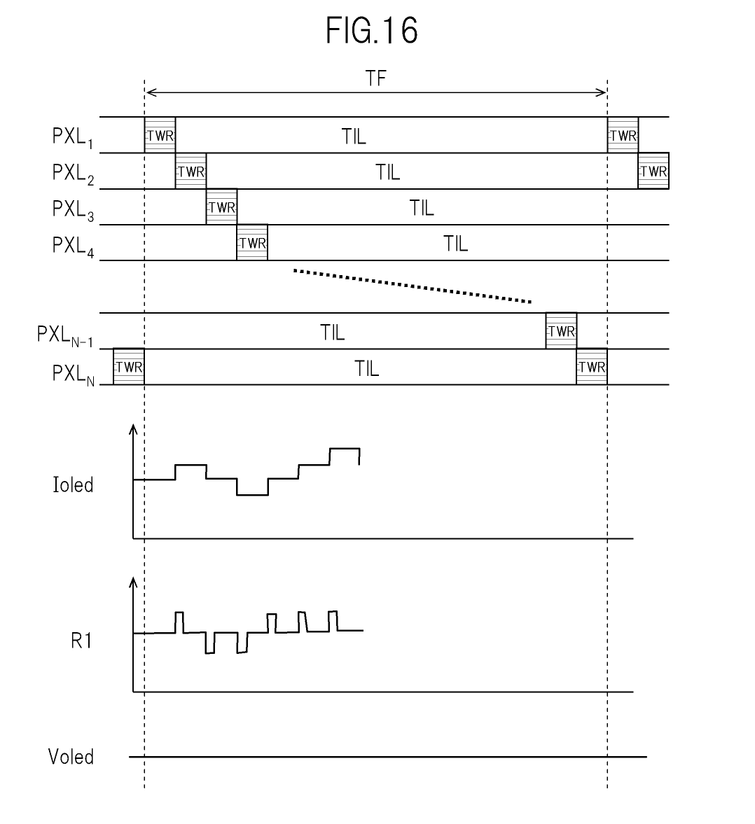

FIG. 16 shows one example of the light-emitting current Ioled which the power source circuit outputs, a resistance value of the first resistor R1 and the light-emitting potential Voled with respect to the power source circuit shown in FIG. 4. The error amplifier input control part PCC controls the resistance value of the first resistor R1. Due to such a control, it is possible to suppress the fluctuation of the light-emitting potential Voled when the light-emitting current Ioled changes each time the new row is scanned. Since the light-emitting potential Voled at the time of writing operation of a display signal to the pixel circuit PC becomes stable, the uniformity of brightness within the display region DA is also enhanced.

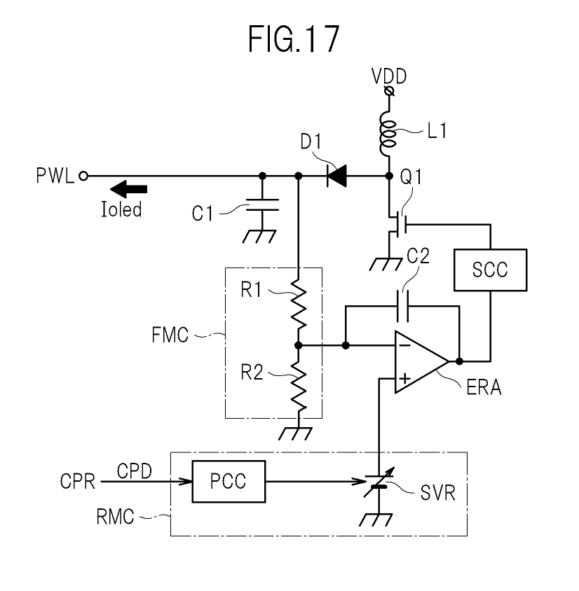

In the power source circuit PWU, it is not always necessary to change the first input potential with respect to the error amplifier ERA. For example, it may be possible to change the second input potential with respect to the error amplifier ERA. Because the error amplifier ERA obtains an integrated value of the potential difference between a first input potential and a second input potential, the error amplifier ERA can acquire the same effect by decreasing the second input potential in place of increasing the first input potential or by increasing the second input potential in place of decreasing the first input potential. FIG. 17 shows another example of the power source circuit PWU according to the second embodiment. This power source circuit PWU differs from the power source circuit PWU shown in FIG. 4 with respect to a point that a first resistor R1 is not a variable resistor, an output voltage of the reference voltage source SVR is variable, and the error amplifier input control part PCC controls an output voltage of the reference voltage source SVR. Here, the reference voltage source SVR and the error amplifier input control part PCC supply a potential obtained by adjusting a reference voltage to the error amplifier ERA as the second input potential. The reference voltage source SVR and the error amplifier input control part PCC are collectively referred to as a reference voltage adjustment circuit RMC.

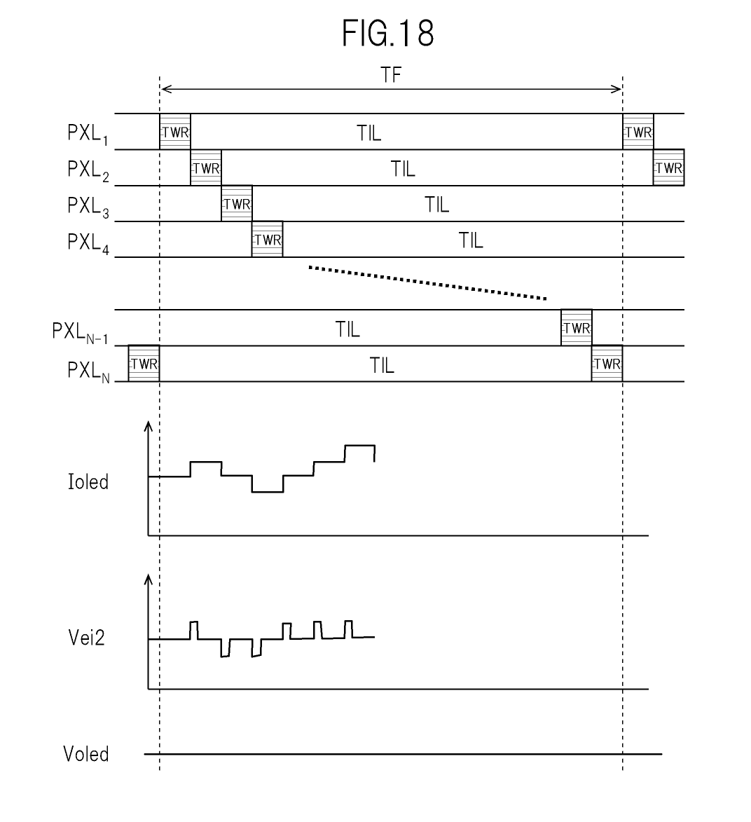

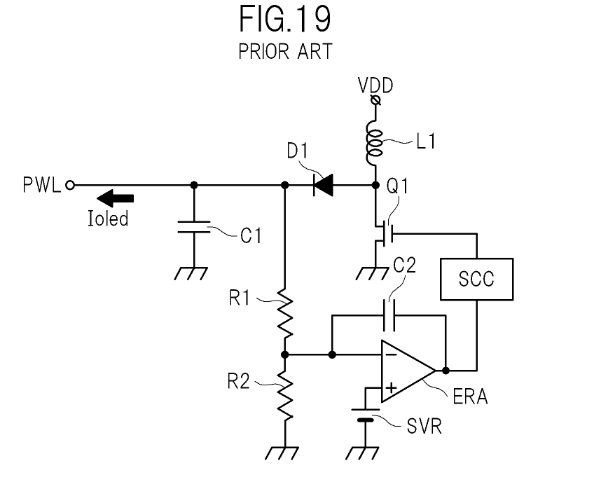

FIG. 18 shows one example of the light-emitting current Ioled which the power source circuit PWU outputs, a second input potential Vei2 which is inputted to an error amplifier ERA, and a light-emitting potential Voled with respect to the power source circuit PWU shown in FIG. 17. In the example shown in FIG. 16 where the resistance value of the first resistor R1 is increased, a control is performed so that the second input potential Vei2 is increased instead of increasing the resistance value of the first resistor R1. Due to such a control, it is possible to suppress a phenomenon that the light-emitting potential Voled fluctuates each time the new row is scanned due to change of the light-emitting current Ioled so that the uniformity of brightness within the display region DA can be also enhanced.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image display device comprising:
a plurality of pixel circuits each of which includes a light emitting element where an amount of light emission changes corresponding to an amount of current and a drive transistor which controls the amount of current which flows to the light emitting element based on a display signal;
a data line drive circuit which supplies the display signal to the plurality of pixel circuits respectively based on image data;
a power source part which outputs a light-emitting potential; and
a current amount prediction part which calculates the amount of current which flows to the plurality of pixel circuits from the power source part based on the image data, wherein
the power source part performs a control for suppressing fluctuation of the light-emitting potential based on the calculated amount of current and the outputted light-emitting potential.

2. The image display device according to claim 1, wherein
the power source part comprises:
a power source input terminal to which a power source potential is inputted;
a switch which controls whether or not a current from the power source input terminal is allowed to flow based on the calculated amount of current and the light-emitting potential; and
a capacitor which has one end to which the light-emitting potential is applied.

3. The image display device according to claim 2, wherein
the power source part further comprises:
an inductance which is provided between the power source input terminal and one end of the switch; and
a rectifying element which is provided between the one end of the switch and the one end of the capacitor.

4. The image display device according to claim 1, wherein
the power source part comprises:
a feedback voltage adjustment circuit which generates a first input potential based on the light-emitting potential and the predicted amount of current;
an error amplifier which detects the difference between the first input potential and a reference potential determined corresponding to the light-emitting potential; and
an output control circuit which performs a control for suppressing the fluctuation of the light-emitting potential based on the detected difference.

5. The image display device according to claim 4, wherein the feedback voltage adjustment circuit comprises:
a first resistor which has one end to which the light-emitting potential is applied and inputs a potential at the other end thereof to the error amplifier as the first input potential; and
a second resistor which has one end which is connected to the other end of the first resistor and the other end to which a ground potential is supplied, and
magnitude of resistance with respect to one of the first resistor and the second resistor changes based on the predicted amount of current.

6. The image display device according to claim 4, wherein the feedback voltage adjustment circuit comprises:
a first resistor which has one end to which the light-emitting potential is applied and inputs a potential at the other end thereof to the error amplifier as the first input potential;
a second resistor which has one end which is connected to the other end of the first resistor and the other end to which a ground potential is supplied; and
a resistance control switch and a third resistor which are arranged in series between the one end of the first resistor and the other end of the first resistor, and
the resistance control switch is controlled based on the predicted amount of current.

7. The image display device according to claim 4, wherein the feedback voltage adjustment circuit comprises:
a first resistor which has one end to which the light-emitting potential is applied and inputs a potential at the other end thereof to the error amplifier as the first input potential;
a second resistor which has one end which is connected to the other end of the first resistor and has the other end to which a ground potential is supplied; and
a current source and a fourth resistor which are connected in series to the other end of the first resistor, and
the feedback voltage adjustment circuit controls whether or not the current source flows a predetermined current based on the predicted amount of current.

8. The image display device according to claim 1, wherein the power source part comprises:
a feedback voltage adjustment circuit which generates a first input potential obtained by dividing the light-emitting potential;
a reference voltage adjustment circuit which generates a second input potential based on the predicted amount of current;
an error amplifier which detects the difference between the first input potential and the second input potential; and
an output control circuit which performs a control of suppressing the fluctuation of the light-emitting potential based on the detected difference.

9. The image display device according to claim 1, wherein the image display device further comprises a data line which has one end to which a display signal from the data line drive circuit is supplied, wherein
the plurality of pixel circuits constitute a predetermined number of pixel rows,
the data line drive circuit sequentially supplies the display signal to the pixel circuits belonging to each pixel row during a writing period, and supplies a light emitting control signal to the plurality of pixel circuits during a light emitting period after the writing period, and
each of the pixel circuits comprises:
a storage capacitor which is provided between the data line and a gate electrode of the drive transistor; and
a reset switch which is provided between a drain electrode and the gate electrode of the drive transistor and is turned on with the supply of the display signal to corresponding one of the pixel circuits.

10. The image display device according to claim 1, wherein the image display device further comprises:
a data line which has one end to which a display signal from the data line drive circuit is supplied; and
a light emitting control signal line,
the plurality of pixel circuits constitute a plurality of pixel rows,
the data line drive circuit sequentially supplies the display signal to the pixel circuits belonging to each pixel row, and
each of the each pixel circuits comprises:
a pixel switch which has one end connected to the data line and is turned on with the supply of the display signal to the pixel circuit;
a storage capacitor which is provided between a gate electrode of the drive transistor and the other end of the pixel switch;
a light emitting control switch which is provided between the light emitting control signal line and the other end of the pixel switch and is turned on after the display signal is supplied; and
a reset switch which is provided between a drain electrode and the gate electrode of the drive transistor and is turned on with the supply of the display signal to the pixel circuit.
